(19) United States
(12) Patent Application Publication
(10) Pub. No.: US 2011/0302193 A1
(43) Pub. Date: Dec. 8, 2011

(54) APPROXIMATION FRAMEWORK FOR DIRECT OPTIMIZATION OF INFORMATION RETRIEVAL MEASURES

(75) Inventors: Tie-Yan Liu, Beijing (CN); Tao Qin, Beijing (CN); Hang Li, Beijing (CN)

(73) Assignee: MICROSOFT CORPORATION, Redmond, WA (US)

(21) Appl. No.: 12/795,628

(22) Filed: Jun. 7, 2010

(51) Int. Cl. G06F 15/18; G06F 17/30

(52) U.S. Cl. 707/769; 706/12; 707/E17.014

(57) ABSTRACT

A “Ranking Optimizer,” provides a framework for directly optimizing conventional information retrieval (IR) measures for use in ranking, search, and recommendation type applications. In general, the Ranking Optimizer first reformats any conventional position based IR measure from a conventional “indexing by position” process to an “indexing by documents” process to create a newly formulated IR measure which contains a position function, and optionally, a truncation function. Both of these functions are non-continuous and non-differentiable. Therefore, the Ranking Optimizer approximates the position function by using a smooth function of ranking scores, and, if used, approximates the optional truncation function with a smooth function of positions of documents. Finally, the Ranking Optimizer optimizes the approximated functions to provide a highly accurate surrogate function for use as a surrogate IR measure.

### BACKGROUND

1. Technical Field

A “Ranking Optimizer,” as described herein, provides a general framework for direct optimization of position-based information retrieval (IR) measures for use in ranking, search, and recommendation type applications.

2. Related Art

Various conventional techniques that provide direct optimization of information retrieval (IR) measures are used in systems that learn ranking functions for objects, lists, etc. In general, many of these techniques can be grouped into one of two different categories. For example, the first of these two categories generally operates by attempting to optimize upper bounds of IR measures as surrogate objective functions. Conversely, the second of these two categories generally operates by approximating IR measures using various smooth functions as surrogates, then conducting optimization on the surrogate objective functions.

Previous studies have shown that the approach of directly optimizing IR measures can achieve good performance when compared to the other conventional techniques for learning ranking functions. However, theoretical analysis provided with conventional approaches is not generally sufficient to provide a solid basis for extending such methods. For example, while it seems intuitive to use the direct optimization approach, theoretical justification for such approaches has not been sufficiently detailed. Further, the relationships between the surrogate functions and corresponding IR measures have not been sufficiently studied. Such issues are relevant because it is necessary to know whether optimizing the surrogate functions can indeed optimize the corresponding IR measures. Finally, many of the proposed surrogate functions are difficult to optimize.

In particular, many existing optimization methods employ complicated techniques that generally require significant computational overhead. For example, several conventional techniques use a “support vector machine” (SVM) based approach to optimize surrogate objective functions. One such technique, referred to as SVM^{MAP}, uses a structured SVM based approach to optimize Mean Average Precision (MAP), while a related technique, referred to as SVM^{NDCG}, uses structured SVM to optimize “Normalized Discounted Cumulative Gain” (NDCG). However, the optimization techniques used for these conventional SVM-based techniques are measure-specific, and thus are not readily directly extensible to new measures.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In general, a “Ranking Optimizer,” as described herein, provides a framework for directly optimizing conventional information retrieval (IR) measures for use in ranking, search, and recommendation type applications that operate response to user entered queries. This general framework accurately approximates any position-based IR measure, and then transforms the optimization of an IR measure to that of an approximated surrogate function. As is well known to those skilled in the art, ranking is the central problem for many IR applications. These applications include, for example, document retrieval, collaborative filtering, key term extraction, definition finding, important email routing, sentiment analysis, product rating, anti web spam, recommendation systems, etc. As such, it should be understood that the Ranking Optimizer can be used for these and other IR-based applications.

As is well known to those skilled in the art, one difficulty in directly optimizing IR measures is that such measures are generally position-based, and thus non-continuous and non-differentiable with respect to a position “score” outputted by the ranking function. However, as discussed herein, if the position of objects or documents can be accurately approximated by a continuous and differentiable function of the scores of the documents, then any position based IR measure can be approximated. In fact, it should be understood that the techniques described herein can be used to learn many kinds of ranking functions, including, for example, linear functions, 2-layer neural nets, or any other non-linear ranking functions (so long as the ranking function is differentiable with respect to its parameters).

Therefore, the Ranking Optimizer first reformats any conventional position based IR measure from a conventional “indexing by position” process to a new “indexing by documents” process (or, more generally, an “indexing by objects” process) to create a newly formulated IR measure that contains a position function, and optionally, a truncation function. Both of these functions are non-continuous and non-differentiable. The Ranking Optimizer then approximates the non-continuous and non-differentiable position function by using a smooth function of ranking scores, and, if used, approximates the optional non-continuous and non-differentiable truncation function with a smooth function of positions of documents. Finally, the Ranking Optimizer optimizes the approximated functions based on one or more sets of training data to generate a highly accurate surrogate function for use as a surrogate IR measure. In general, this training data is dependent upon the particular IR measure being evaluated. For example, in the case of a document search type IR measure, the training data would consist of ranked lists of documents associated with each query in a set of queries provided by one or more users.

In other words, the general framework to approximate position based IR measures provided by the Ranking Optimizer approximates the positions of documents (or other objects) by their ranking scores. For example, the highest ranking documents will generally have the highest positions. As such, ranking scores provide a good measure approximating document (or object) positions. There are several advantages of this framework. First, the techniques described herein for approximating position-based measures is simple yet general. Further, many existing techniques can be directly applied to the optimization and the optimization process itself is measure independent. Finally, it is a simple matter to conduct analysis on the accuracy of the approach and high approximation accuracy can be achieved by setting appropriate parameters, as described in further detail herein.

In view of the above summary, it is clear that the Ranking Optimizer described herein provides various unique techniques for directly optimizing conventional IR measures for use in ranking, search, and recommendation type applications. In addition to the just described benefits, other advantages of the Ranking Optimizer will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates program modules for implementing various embodiments of a “Ranking Optimizer” for use in learning an optimized information retrieval (IR) surrogate function to replace an initial position-based IR measure,” as described herein.

FIG. 2 illustrates a general system flow diagram that illustrates exemplary methods for implementing various embodiments of the Ranking Optimizer, as described herein.

FIG. 3 is a general system diagram depicting a simplified general-purpose computing device having simplified computing and I/O capabilities for use in implementing various embodiments of the Ranking Optimizer, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

In general, a “Ranking Optimizer,” as described herein, provides various techniques for directly optimizing conventional information retrieval (IR) measures for use in ranking, search, and recommendation type applications that operate response to user entered queries. As is well known to those skilled in the art, ranking is the central problem for many IR applications. These applications include, for example, document retrieval, collaborative filtering, key term extraction, definition finding, important email routing, sentiment analysis, product rating, anti web spam, recommendation systems, etc. As such, it should be understood that the Ranking Optimizer can be used for these and other IR-based applications.

More specifically, regardless of the specific application, the Ranking Optimizer first reformats any conventional position-based IR measure from a conventional “indexing by position” process to an “indexing by documents” process (or more generally, an indexing by object process) to create a newly formulated IR measure that contains a position function, and optionally, a truncation function. Note that unless the original position-based IR measure included a truncation function, the newly formulated IR measure will not include the optional truncation function. In either case, both of these functions (i.e., the position function and optional truncation function) are non-continuous and non-differentiable.

The Ranking Optimizer then approximates the non-continuous and non-differentiable position function using a smooth function of ranking scores. In addition, if used, the Ranking Optimizer also approximates the optional non-continuous and non-differentiable truncation function with a smooth function of positions of documents. Finally, the Ranking Optimizer optimizes these approximated functions based on one or more sets of training data by using iterative learning process to generate a highly accurate surrogate function for use as a surrogate IR measure. In general, this training data is dependent upon the particular IR measure being evaluated. For example, in the case of a document search type IR measure, the training data would consist of ranked lists of documents associated with each user-entered query in a set of queries.

Note that throughout this document, the term “documents” is used for purposes of explanation when referring to such things as an “indexing by documents” process. However, it should be understood that in the more general case, the Ranking Optimizer is intended to be used in a variety of information retrieval scenarios that may relate to any object or data (e.g., books, movies, names, data elements, etc.) that is the focus of the information retrieval measure being optimized by the processes described herein.

Note also that for purposes of explanation, “AP” (Average Precision) and “NDCG” (Normalized Discounted Cumulative Gain) are used as examples to show how to approximate IR measures within the overall framework of the Ranking Optimizer. These measures are also used to provide examples of how to analyze the accuracy of approximations, and how to derive effective learning algorithms to optimize the approximated functions. However, it should be understood that these measures are used only for purposes of explanation, and that other measures, such as, for example, Precision, NDCG@k, MRR, Kendall's τ, etc. may also be used, if desired, by adapting the techniques described herein for the specific measures. It should also be noted that the detailed description of the Ranking Optimizer provided herein makes use of simple gradient methods to optimize the approximated functions. It should be understood that other optimizations beyond simple gradients may also be used, if desired, without departing from the scope of the optimization framework described herein.

1.1 System Overview:

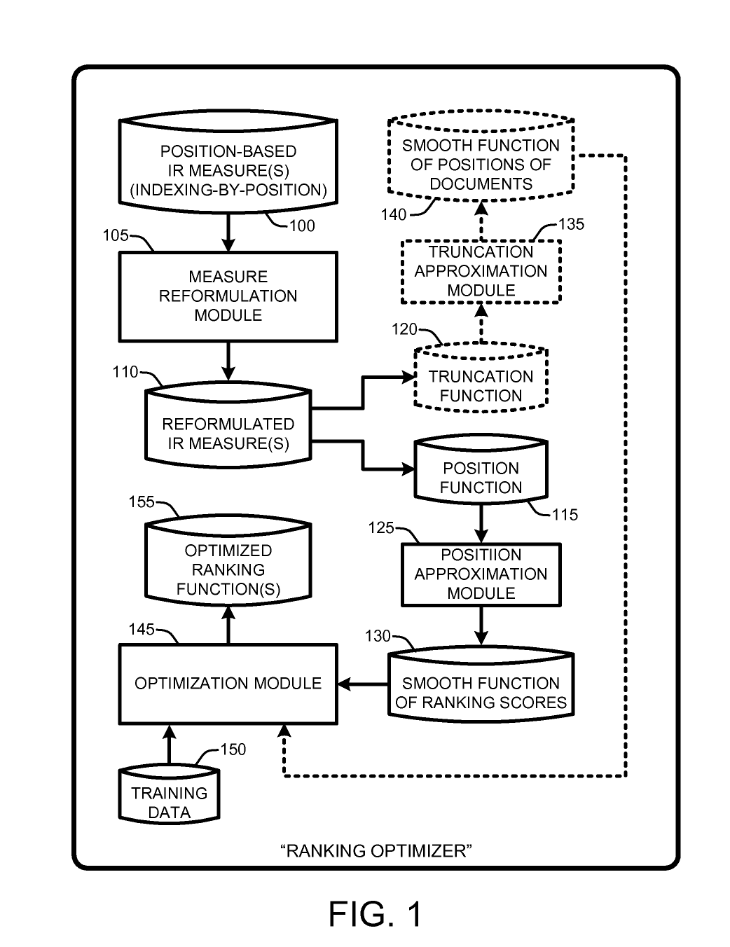

As noted above, the “Ranking Optimizer,” provides various techniques for directly optimizing position based information retrieval (IR) measures for use in ranking, search, and recommendation type applications. The processes summarized above are illustrated by the general system diagram of FIG. 1. In particular, the system diagram of FIG. 1 illustrates the interrelationships between program modules for implementing various embodiments of the Ranking Optimizer, as described herein. Furthermore, while the system diagram of FIG. 1 illustrates a high-level view of various embodiments of the Ranking Optimizer, FIG. 1 is not intended to provide an exhaustive or complete illustration of every possible embodiment of the Ranking Optimizer as described throughout this document.

In addition, it should be noted that any boxes and interconnections between boxes that may be represented by broken or dashed lines in FIG. 1 represent alternate embodiments of the Ranking Optimizer described herein, and that any or all of these alternate embodiments, as described below, may be used in combination with other alternate embodiments that are described throughout this document.

In general, as illustrated by FIG. 1, the processes enabled by the Ranking Optimizer begin operation by supplying a conventional position-based IR measure 100, such as, for example, AP, NDCG, Precision, NDCG@k, MRR, Kendall's r, etc., to a measure reformulation module 105. As is known to those skilled in the art, some conventional position-based IR measures also include a “truncation function” depending upon the definition of those functions. For example, Section 2.3.1 discusses an example of a truncation function associated with the conventional “Precision@k” IR measure which includes a truncation function indicating whether a document x is ranked in the top k positions. The measure reformulation module 105 acts to reformulate the position-based IR measure 100 to produce a corresponding reformulated IR measure 110 that consists of a position function 115 and an optional truncation function 120 (only in the case that the IR measure 100 included a truncation function in its definition). More specifically, as discussed in further detail in Section 2.3.1, the reformulation process performed by the measure reformulation module 105 changes the position-based IR measure 100 to a reformulated IR measure 110 that makes use of the indices of documents, rather than the position of those documents. Again, the reformulated IR measure 110 is represented by the aforementioned position function 115 and the optional truncation function 120.

Both the position function 115 and the optional truncation function 120 are non-continuous and non-differentiable functions. Consequently, as described in detail in Section 2.3.2, the next step in the overall process is to provide the position function 115 to a position approximation module 125 that uses any desired sigmoid function to approximate the position function 115 with a smooth function of ranking scores 130. Similarly, as described in detail in Section 2.3.3, the optional truncation function 120, if used, is provided to a truncation approximation module 135 that uses any desired sigmoid function to approximate the truncation function 120 with a smooth function of positions of documents 140.

Finally, the smooth function of ranking scores 130 and the optional smooth function of positions of documents 140 are provided to an optimization module 145 that uses an iterative learning process in combination with a set of training data 150 to optimize the smooth function of ranking scores 130 (and optionally the smooth function of positions of documents 140). The end result of the iterative learning process is an optimized ranking function 155 (also referred to herein as a surrogate IR measure). For example, in the case of a position-based IR measure 100 used to evaluate document positions (such as, for example, a typical document retrieval process based on document positions), the resulting surrogate function would be represented by a learned function for document retrieval based on an indexing by documents process rather than the original position-based process.

2.0 Operational Details of the Ranking Optimizer:

The above-described program modules are employed for implementing various embodiments of the Ranking Optimizer. As summarized above, the Ranking Optimizer provides various techniques for directly optimizing position based information retrieval (IR) measures for use in ranking, search, and recommendation type applications. The following sections provide a detailed discussion of the operation of various embodiments of the Ranking Optimizer, and of exemplary methods for implementing the program modules described in Section 1 with respect to FIG. 1. In particular, the following sections examples and operational details of various embodiments of the Ranking Optimizer, including: a discussion of conventional position-based IR processes; a theoretical justification of the optimization techniques utilized by the Ranking Optimizer; the general direct optimization framework used by the Ranking optimizer to learn surrogate IR measures; and a theoretical analysis the of the optimization techniques enabled by the Ranking Optimizer.

2.1 Discussion of Conventional Position-Based IR Processes:

To evaluate the effectiveness of a ranking model, conventional IR measures such as “Precision”, “AP” (Average Precision), “NDCG” (Normalized Discounted Cumulative Gain) and “MRR” (Mean Reciprocal Rank) are often used.

For example, the well-known “Precision@k” (or “Pre@k”) is a measure for evaluating the top k positions of a ranked list using two levels (relevant and irrelevant) of relevance judgement, where:

$$Pre @ k = \frac{1}{k} {\sum }_{j = 1}^{k} {r}_{j} , \qquad Equation ( 1 )$$

where k denotes the truncation position, and

$${r}_{j} = ( \begin{matrix}1 & if document in {j}^{th} position is “ relevant ” \\ 0 & otherwise\end{matrix} \qquad Equation ( 2 )$$

AP, or “Average Precision”, is another well-known IR measure that uses two levels of relevance judgment. AP is generally defined in terms of the above defined Precision@k, as follows:

$$AP = \frac{1}{\vert {D}_{+} \vert} {\sum }_{j} {r}_{j} \times Pre @ j , \qquad Equation ( 3 )$$

where |D₊| denotes the number of relevant documents with respect to the query. Therefore, given a ranked list for a query, the AP for this query can be computed. Note that the “mean average precision” (MAP) is defined simply as the mean of AP over a set of queries.

The well-known “NDCG@k” is a measure for evaluating top k positions of a ranked list using multiple levels (labels) of relevance judgment. In general, NDCG@k is defined as illustrated by Equation (4), where:

$$NDCG @ k = {N}_{k}^{- 1} {\sum }_{j = 1}^{k} g ( {r}_{j} ) d ( j ) , \qquad Equation ( 4 )$$

where k is the same as that in Equation (1), Nₖ denotes the maximum of Σⱼ₌₁^{k}g(rⱼ)d(j) (note that the maximum is obtained when the documents are ranked in the “perfect” order), rⱼ denotes the relevance level of the document ranked at the j^{th} position, g(rⱼ) denotes a gain function, e.g., g(rⱼ)=2^{r}^{ⱼ}−1, and d(j) denotes a discount function, e.g., d(j)=1/log₂(1+j).

Further, given the specific definitions of the gain function and the discount function shown above, NDCG@k can be reformulated as illustrated by Equation (5), where:

$$NDCG @ k = {N}_{k}^{- 1} {\sum }_{j = 1}^{k} \frac{{2}^{{r}_{j}} - 1}{{log}_{2} ( 1 + j )} . \qquad Equation ( 5 )$$

If considering all the n documents for a query, the measure “NDCG@n” is used. Note that NDCG@n is referred to simply as “NDCG” throughout the remainder of this document, where:

$$NDCG = NDCG @ n = {N}_{n}^{- 1} {\sum }_{j = 1}^{n} \frac{{2}^{{r}_{j}} - 1}{{log}_{2} ( 1 + j )} . \qquad Equation ( 6 )$$

2.1.1 Learning to Rank:

Conventionally, learning to rank is generally aimed at constructing a ranking function ƒ with training data consisting of queries and their associated documents. The constructed function is then used in ranking, specifically, to assign a score to each document associated with a query, to sort the documents in the descending order of the scores, and to generate the final ranking list of documents for the query.

One conventional approach in learning to rank takes document pairs as instances and reduces the problem of ranking to that of classification on the orders of document pairs. This conventional approach then applies existing classification techniques to ranking. Such methods include the well-known “Ranking SVM,” “RankBoost,” and “RankNet” techniques, among others.

Another conventional approach regards ranking lists as instances, and conducts learning on the lists of documents. For example, one such technique uses a probabilistic model in the ranking learning process and employs a list-wise ranking algorithm referred to as “ListNet.” This conventional approach has been expanded to include the properties of related algorithms to derive a new algorithm based on Maximum Likelihood to provide another conventional approach referred to as “ListMLE.”

2.1.2 Direct Optimization of IR Measures:

In addition to the learning to rank methods described above, various studies have been made on how to learn a ranking function by directly optimizing an IR measure. This new approach seems more straightforward and appealing, because what is used in evaluation is exactly an IR measure.

There are two major categories of algorithms for direct optimization of IR measures. One group of algorithms attempts to optimize objective functions that are bounds of the IR measures. For example, SVM^{MAP} minimizes a hinge loss function, which bounds 1-AP (see discussion of AP above). In contrast, SVM^{NDCG} minimizes a hinge loss function, which bounds 1-NDCG (see discussion of NDCG above). On the other hand, AdaRank minimizes an exponential loss function that can upper bound either 1-AP or 1-NDCG. Another group of algorithms manages to smooth the IR measures with easy-to-optimize functions. For example, “SoftRank” smoothes NDCG by introducing randomness into the relevance scores of documents.

The effectiveness of the above-described algorithms has been empirically verified. However, as noted above, a sufficient theoretical analysis on these types of algorithms has not been previously provided.

2.2 Theoretical Justification of Optimization Techniques:

The following paragraphs provide a theoretical justification to the approach used by the Ranking Optimizer for directly optimizing IR measures. This theoretical justification is based, in part, on the well-known consistency theory of empirical learning processes and the well-known generalization theory in statistical machine learning.

For example, based on the well-known consistency theory in statistical learning, an IR measure is bounded and the function class is not very complex. Therefore, directly optimizing the IR measure on a large training set can guarantee a very good (i.e., highly accurate) test performance in terms of the same IR measure. Further, in view of the well-known generalization theory, under certain conditions, no other approach can outperform optimization approaches based on direct optimization of IR measures in a large sample limit.

Therefore, if an algorithm can directly optimize an IR measure on the training data, then the ranking function learned by that algorithm will be one of the best ranking functions that can be obtained in terms of the expected test performance defined by the same IR measure. The Ranking Optimizer described herein enables such direct optimization techniques to generate highly accurate surrogate IR measure for use in ranking, search, and recommendation type applications.

2.2.1 Training Performance vs. Testing Performance:

Suppose that {qᵢ,i=1, 2, . . . , m} represents m training queries and q represents a test query, sampled from the entire query space (i.e., all queries from all users, or some specific subset thereof), according to an unknown probability distribution, P(q). Further, the term M(q, ƒ) is used to denote the performance of ranking function ƒεF with regards to query q in terms of IR measure, M. Then, M(ƒ) and Mₘ(ƒ), defined below, represent the expected test performance and the empirical training performance of the ranking function ƒ in terms of IR measure M:

$$\begin{matrix}M ( f ) = \int M ( q , f ) d P ( q ) & Equation ( 7 ) \\ {M}_{m} ( f ) = \frac{1}{m} {\sum }_{i = 1}^{m} M ( {q}_{i} , f ) & Equation ( 8 )\end{matrix}$$

These equations then lead to the following theorem on the consistency of empirical learning-to-rank process, which is further illustrated with respect to Equation (9):
Theorem 1: If the ranking function space F is not complex, and the IR measure M(q, ƒ) is uniformly bounded over the function space, F, then the training performance Mₘ(ƒ) of a learning to rank algorithm uniformly converges to the test performance M(ƒ) of the learning to rank algorithm.

$$P \{ {sup}_{f ∈ ℱ} \vert M ( f ) - {M}_{m} ( f ) \vert > ɛ \} {\to }^{m -> ∞} 0 \qquad Equation ( 9 )$$

Note that as is well known to those skilled in the art of statistics, the complexity of a function space is strictly defined. For example, a space containing a finite number of functions is not “complex.”

Since most IR measures, including NDCG, MAP, Precision, etc., take values from [0,1], the corresponding M(q, ƒ) is uniformly bounded for any ranking function ƒεF. Theorem 1 implies that under certain conditions, the training performance of a ranking function will be very close to the test performance of the ranking function, when the number of training queries becomes large (i.e., |M(ƒ)−Mₘ(ƒ)|^{m→∞}→0).

It is easy to understand that if an algorithm can directly optimize an IR measure on the training set, then the learned ranking function will have a high performance on the training set. Theorem 1 pushes this concept further by suggesting that the ranking function is very likely to have a high performance on the test set as well, when the training set is large enough. This concept provides a theoretical justification to the approach of directly optimizing IR measures in learning to rank used by the Ranking Optimizer.

2.2.2 Direct Optimization vs. Other Methods:

An even stronger conclusion can be drawn from the generalization theory. That is, when the number of training queries is extremely large, the learned ranking function in direct optimization of IR measures will be the best ranking function that can be obtained in terms of the measures.

In particular, the term ƒₘ is used to denote the ranking function in F with the best possible training performance in terms of the IR measure M, and ƒ* to denote the ranking function in F with the best testing performance, also in terms of M:

$$\begin{matrix}{f}_{m} = {arg max}_{f ∈ ℱ} {M}_{m} ( f ) & Equation ( 10 ) \\ {f}^{*} = {arg max}_{f ∈ ℱ} M ( f ) & Equation ( 11 )\end{matrix}$$

These ideas lead to Theorem 2, as follows:
Theorem 2: The difference between the testing performance of ƒₘ and the testing performance of ƒ* can be bounded as illustrated by Equation (12):

$$\vert M ( {f}_{m} ) - M ( {f}^{*} ) \vert \leq 2 {sup}_{f ∈ ℱ} \vert M ( f ) - {M}_{m} ( f ) \vert \qquad Equation ( 12 )$$

Combining the results above Theorem 1 and Theorem 2 yields Equation (13), as follows:

$$\vert M ( {f}_{m} ) - M ( {f}^{*} ) \vert {\to }^{m -> ∞} 0 \qquad Equation ( 13 )$$

Note that, in view of the above definitions, M(ƒ*) is the best test performance that can be obtained over the entire function space. For ranking functions learned by other methods, Theorem 2 does not necessarily hold. Therefore, it can be stated that no other learning to rank algorithms can perform better than the approach of directly optimizing IR measures in the large sample limit.

2.2.3 Remarks:

Theorem 1 and Theorem 2 hold only when the conditions stated in these theorems are met.
1) For some unbounded IR measures, such as DCG, there is no guarantee that the same conclusion holds as in Theorem 1. As a result, it is not clear whether high training performance can result in very good (i.e., highly accurate) testing performance in terms of such measures.
2) Note that Theorem 1 and Theorem 2 hold only in the large sample limit. However, in practice, the amount of training data is always finite. As such, the performance of the direct optimization process is dependent upon the amount of data, as is generally the case with any learning algorithm.

3) As is well known to those skilled in the art, conventional direct optimization methods generally attempt to optimize surrogate objective functions but not IR measures. In many cases, the relationships between the surrogate functions and the IR measures have not been verified. Thus, it is not clear whether particular conventional direct optimization algorithms can outperform other conventional methods in the large sample limit.

2.3 General Direct Optimization Framework:

The following paragraphs describe a general framework for direct optimization of IR measures. This framework is applicable to any position based IR measure, it is theoretically justifiable, easy to use, and empirically effective. Further, this framework takes the approach of approximating the IR measures. In general, this direct optimization framework consists of four steps:
1) Reformulating an IR measure from “indexing by positions” to “indexing by documents”. The newly formulated IR measure then contains a position function and, optionally, a truncation function. Both functions are non-continuous and non-differentiable.
2) Approximating the position function with a smooth function of ranking scores.
3) Approximating the truncation function with a smooth function of positions of documents.
4) Applying an optimization technique to optimize the approximated measure(s) in view of one or more sets of training data to generate the surrogate function (i.e., the surrogate IR measure).

Note that with the first three steps above, the surrogate objective functions become continuous and differentiable with respect to the parameter in the ranking function, one can choose many conventional optimization algorithms, such as, for example, the gradient ascent method, the steepest ascent method, Newton's method, the SR1 formula (i.e., Symmetric Rank 1), the BFGS method (i.e., the Broyden-Fletcher-Goldfarb-Shanno method), L-BFGS method, (i.e., the limited memory Broyden-Fletcher-Goldfarb-Shanno method), and so on. However, as noted above, for purposes of explanation, the simple gradient ascent method is used by various embodiments of the Ranking Optimizer as described herein.

Next, for purposes of explanation, several examples are provided to explain the above steps in detail using the following notations and definitions:

Suppose that X is a set of documents for a query, and x is an element in X. A ranking function ƒ outputs a score sₓ for each x, as illustrated by Equation (14):

sₓ=ƒ(x;θ),xεX Equation (14)

where θ denotes the parameter of ƒ. A ranked list π can be obtained by sorting the documents in descending order of their scores. The term π(x) is used to denote the position of document x in the ranked list π. Given the relevance label r(x) of each document x, an IR measure can be used to evaluate the goodness of π. Note that different ƒ's will generate different π's and thus achieve different ranking performances in terms of the IR measure. The approach of direct optimization is to find an optimal ƒ from a function class F by directly optimizing the performance on the data in terms of the IR measure. Further, the tern 1{A} is used to denote an indicator function, as illustrated by Equation (15):

$$1 \{ A \} = ( \begin{matrix}1 , & if A is true , \\ 0 , & otherwise .\end{matrix} \qquad Equation ( 15 )$$

2.3.1 Measure Reformulation:

Most IR measures, for example, Precision, AP, NDCG, etc., are position based. Specifically, the summations in the definitions of IR measures are taken over positions, as can be seen in Equation (1), (2), (3) and (4). Unfortunately, the position of a document may change during the training process, which makes the handling of the IR measures difficult. To deal with the problem, the Ranking Optimizer reformulates IR measures using the indices of documents.

For example, when indexed by documents, Precision@k in Equation (1) can be re-written as:

$$Pre @ k = \frac{1}{k} {\sum }_{x ∈ 𝒳} r ( x ) 1 \{ π ( x ) \leq k \} \qquad Equation ( 16 )$$

where r(x) equals 1 for relevant documents and 0 for irrelevant documents, and 1{π(x)≦k} is a truncation function indicating whether document x is ranked in the top k positions. If a document is ranked in the k+1 position, the truncation function will return a value of 0, for that document and all subsequent documents in positions greater than k+1. In other words, the truncation function acts to truncate the IR measure for all documents below a certain position (denoted by k in this case).

With documents as indices, AP in Equation (3) can be re-written as illustrated by Equation (17):

$$AP = \frac{1}{\vert {D}_{+} \vert} {\sum }_{y ∈ 𝒳} r ( y ) \times Pre @ π ( y ) . \qquad Equation ( 17 )$$

Combining Equation (16) and Equation (17) yields:

$$\begin{matrix}A P = \frac{1}{\vert {D}_{+} \vert} {\sum }_{y ∈ X} r ( y ) \times \frac{1}{π ( y )} {\sum }_{x ∈ X} r ( x ) 1 \{ π ( x ) \leq π ( y ) \} \\ = \frac{1}{\vert {D}_{+} \vert} {\sum }_{y ∈ X} ( \frac{r ( y )}{π ( y )} + {\sum }_{x ∈ X , x \neq y} r ( y ) r ( x ) \frac{1 \{ π ( x ) < π ( y ) \}}{π ( y )} )\end{matrix} \qquad Equation ( 18 )$$

where 1{π(x)<π(y)} is also a truncation function indicating whether document x is ranked before document y.

Similarly, when indexed by documents, Equation (4), illustrating NDCG@k, can be re-written as:

$$N D C G @ k = {N}_{k}^{- 1} {\sum }_{x ∈ X} \frac{{2}^{r ( x )} - 1}{{log}_{2} ( 1 + π ( x ) )} 1 \{ π ( x ) \leq k \} . \qquad Equation ( 19 )$$

Here r(x) is an integer, where increasing values indicate increasing relevance. For example, r(x)=0 means that document x is irrelevant to the query, and r(x)=4 means that the document is very relevant to the query. Note that NDCG does not need the truncation function, as illustrated below:

$$N D C G = {N}_{n}^{- 1} {\sum }_{x ∈ X} \frac{{2}^{r ( x )} - 1}{{log}_{2} ( 1 + π ( x ) )} \qquad Equation ( 20 )$$

The reformulated IR measures (e.g., Equation (16), (18), (19) and (20)) contain two kinds of functions: position function π(x) and truncation functions 1{π(x)<π(y)} and 1{π(x)≦k}. Both the position and truncation functions are non-continuous and non-differentiable. The following subsections (i.e., Section 2.3.2 and Section 2.3.3) discuss how to approximate these functions separately.

2.3.2 Position Function Approximation:

The position function can be represented as a function of ranking scores:

$$π ( x ) = 1 + {\sum }_{y ∈ X , y \neq x} 1 \{ {s}_{x , y} < 0 \} \qquad Equation ( 21 )$$

where s_{x,y}=sₓ−s_{y}.

In other words, positions can be regarded as outputs of a function of ranking scores. Unfortunately, the position function is non-continuous and non-differentiable because the indicator function itself is non-continuous and non-differentiable.

Therefore, the Ranking Optimizer acts to approximate the position function to make it easy to handle. One natural way to address this approximation is to approximate the indicator function 1{s_{x,y}<0} using a logistic function such as illustrated below in Equation (22).

$$\frac{exp ( - α {s}_{x , y} )}{1 + exp ( - α {s}_{x , y} )} \qquad Equation ( 22 )$$

where α>0 is a scaling constant. Note that in general, a large α value will allow the Ranking Optimizer to provide better precision with the final surrogate IR measure. However, smaller α values present a case wherein optimization is simpler (i.e., requires less computational overhead), with a corresponding decrease in the accuracy of the surrogate IR measure.

Next, π(x) can be replaced with \hat{π}(x) to provide the following:

$$\hat{π} ( x ) = 1 + {\sum }_{y ∈ X , y \neq x} \frac{exp ( - α {s}_{x , y} )}{1 + exp ( - α {s}_{x , y} )} \qquad Equation ( 23 )$$

where \hat{π}(x) is a continuous and differentiable function.

Table 1 shows an example of the above position approximation process. Note that the approximation, \hat{π}(x), is very accurate in this case relative to π(x).

TABLE 1
Examples of Position Approximation

| Document | sₓ | π(x) | \hat{π}(x) (α = 100) |
|---|---|---|---|
| x₁ | 4.20074 | 2 | 2.00118 |
| x₂ | 3.12378 | 4 | 4.00000 |
| x₃ | 4.40918 | 1 | 1.00000 |
| x₄ | 1.55258 | 5 | 5.00000 |
| x₅ | 4.13330 | 3 | 2.99882 |

Note that the logistic function illustrated above in Equation (22) is a special case of sigmoid functions. In fact, any desired sigmoid function can be used for this approximation, such as the ordinary arc-tangent function, the hyperbolic tangent function, the error function, etc. However, for purposes of explanation, the following discussion uses the logistic function as an example. Consequently, is should be understood that all the derivations and conclusions discussed herein with respect to the logistic function can be naturally extended to other sigmoid functions. In fact, since the logistic function is approximating the well-known “Heaviside Step Function” ƒ(x) (i.e., a unit step function), the Ranking Optimizer can use even broader function class, g(x). In this case, the only requirement is that g(x) is a continuous function that approaches 0 for x<0 and that approaches 1 for x>0.

The approximation of NDCG can be obtained by simply replacing π(x) in Equation (20) with \hat{π}(x) to provide the following:

$$\hat{N D C G} = {N}_{n}^{- 1} {\sum }_{x ∈ X} \frac{{2}^{r ( x )} - 1}{{log}_{2} ( 1 + \hat{π} ( x ) )} \qquad Equation ( 24 )$$

2.3.3 Truncation Function Approximation:

As can be seen in Section 2.3.1, some measures have truncation functions in their definitions, such as Precision@k, AP, and NDCG@k. These measures need further approximation on the truncation functions. Again, as noted above, if the original IR measure does not include a truncation function, then there is no need to approximate a truncation function, as described below. The following paragraphs describe how approximation on the truncation functions is achieved within the overall optimization framework of the Ranking Optimizer. Note that some measures, including NDCG for example, do not have truncation functions. In such cases (i.e., no truncation function), the techniques described below can be skipped.

For purposes of explanation, AP is used as an example to show how to approximate the truncation function and then approximate the measure.

In particular, to approximate AP, it is necessary to approximate the truncation function 1{π(x)<π(y)} in Equation (18). One simple way to do this is to use a logistic function illustrated by Equation (25). Note that similar to position approximation, other sigmoid functions may also be used, if desired.

$$\frac{exp ( β ( \hat{π} ( y ) - \hat{π} ( x ) ) )}{1 + exp ( β ( \hat{π} ( y ) - \hat{π} ( x ) ) )} \qquad Equation ( 25 )$$

in which β>0 is a scaling constant. Note that in general, a large β value will allow the Ranking Optimizer to provide better precision with the final surrogate IR measure. However, smaller β values present a case wherein optimization is simpler (i.e., requires less computational overhead), with a corresponding decrease in the accuracy of the surrogate IR measure.

This results in the following approximation of AP:

$$\hat{AP} = \frac{1}{\vert {D}_{+} \vert} {\sum }_{y} ( \frac{r ( y )}{\hat{π} ( y )} + {\sum }_{x \neq y} \frac{r ( y ) r ( x )}{\hat{π} ( y )} \frac{exp ( β ( \hat{π} ( y ) - \hat{π} ( x ) ) )}{1 + exp ( β ( \hat{π} ( y ) - \hat{π} ( x ) ) )} ) \qquad Eqn . ( 26 )$$

2.3.4 Surrogate Function Optimization:

With the aforementioned approximation technique, the surrogate objective functions (e.g., [symbol] and [symbol] ) become continuous and differentiable with respect to the parameter θ in the ranking function. Thus, one can choose from among many conventional optimization algorithms, e.g., the simple gradient method, to maximize them.

Again, AP and NDCG are used as examples to show how to perform the optimization, with the corresponding algorithms being referred to as ApproxAP and ApproxNDCG respectively. The derivation of gradients of [symbol] and [symbol] (i.e., the surrogate IR measures corresponding to the conventional AP and NDCG IR measures discussed above) is discussed below.

For example, the gradient,

$${Δθ}_{ApproxNDCG} = \frac{\partial \hat{NDCG}}{\partial θ}$$

for ApproxNDCG is derived by first applying the chain rule to obtain the gradient:

$$Δθ = \frac{\partial \hat{NDCG}}{\partial θ} = {N}_{n}^{- 1} {\sum }_{x} \frac{\partial \frac{{2}^{r ( x )} - 1}{{log}_{2} ( 1 + \hat{π} ( x ) )}}{\partial \hat{π} ( x )} \frac{\partial \hat{π} ( x )}{\partial θ} \qquad Equation ( 27 )$$

### Further,

$$\begin{matrix}\begin{matrix}\frac{\partial \hat{π} ( x )}{\partial θ} = - α {\sum }_{y \neq x} \frac{exp ( α {s}_{xy} )}{{( 1 + exp ( α {s}_{xy} ) )}^{2}} \frac{\partial {s}_{xy}}{\partial θ} \\ = - α {\sum }_{y \neq x} \frac{exp ( α {s}_{xy} )}{{( 1 + exp ( α {s}_{xy} ) )}^{2}} ( \frac{\partial f ( x ; θ )}{\partial θ} - \frac{\partial f ( y ; θ )}{\partial θ} )\end{matrix} & Equation ( 28 ) \\ \begin{matrix}\frac{\partial \frac{{2}^{r ( x )} - 1}{{log}_{2} ( 1 + \hat{π} ( x ) )}}{\partial \hat{π} ( x )} = - \frac{{2}^{r ( x )} - 1}{{( {log}_{2} ( 1 + \hat{π} ( x ) ) )}^{2}} \frac{1}{( 1 + \hat{π} ( x ) ) ln 2} \\ = - α {\sum }_{y \neq x} \frac{exp ( α {s}_{xy} )}{{( 1 + exp ( α {s}_{xy} ) )}^{2}} \\ ( \frac{\partial f ( x ; θ )}{\partial θ} - \frac{\partial f ( y ; θ )}{\partial θ} )\end{matrix} & Equation ( 29 )\end{matrix}$$

Therefore, by substituting Equations (28) and (29) into (27), the gradient for ApproxNDCG (i.e., Δθ_{ApproxNDCG}) is obtained. Note that

$$\frac{\partial f ( x ; θ )}{\partial θ}$$

in Equation (28) depends on the specific form of the ranking function ƒ. For example, for a linear function,

$$\frac{\partial f ( x ; θ )}{\partial θ} = x .$$

Similarly, the gradient,

$$Δ {θ}_{ApproxAP} = \frac{\partial \hat{AP}}{\partial θ} ,$$

for ApproxAP is derived by first applying the chain rule to obtain the gradient:

$$\frac{\partial \hat{AP}}{\partial θ} = \frac{- 1}{\vert {D}_{+} \vert} {\sum }_{y} \frac{r ( y )}{{\hat{π}}^{2} ( y )} \frac{\partial \hat{π} ( y )}{\partial θ} + \frac{1}{\vert {D}_{+} \vert} {\sum }_{y} {\sum }_{x \neq y} r ( y ) r ( x ) \frac{\partial J ( θ )}{\partial θ} \qquad Equation ( 30 )$$

where:

$$J ( θ ) = \frac{1}{\hat{π} ( y )} \frac{exp ( β ( \hat{π} ( y ) - \hat{π} ( x ) ) )}{1 + exp ( β ( \hat{π} ( y ) - \hat{π} ( x ) ) )} \qquad Equation ( 31 )$$

Again, by the chain rule,

$$\frac{\partial J ( θ )}{\partial θ} = \frac{\partial J ( θ )}{\partial \hat{π} ( y )} \frac{\partial \hat{π} ( y )}{\partial θ} + \frac{\partial J ( θ )}{\partial \hat{π} ( x )} \frac{\partial \hat{π} ( x )}{\partial θ} \qquad Equation ( 32 )$$

Now, considering

$$\frac{\partial J ( θ )}{\partial \hat{π} ( x )} and \frac{\partial J ( θ )}{\partial \hat{π} ( y )} :$$

$$\begin{matrix} \frac{\partial J ( θ )}{\partial \hat{π} ( x )} = \frac{- 1}{\hat{π} ( y )} \frac{β exp ( β ( \hat{π} ( x ) - \hat{π} ( y ) ) )}{{( 1 + exp ( β ( \hat{π} ( x ) - \hat{π} ( y ) ) ) )}^{2}} & Equation ( 33 ) \\ \frac{\partial J ( θ )}{\partial \hat{π} ( y )} = \frac{- 1}{{\hat{π}}^{2} ( y )} \frac{1}{1 + exp ( β ( \hat{π} ( x ) - \hat{π} ( y ) ) )} + \frac{1}{\hat{π} ( y )} \frac{βexp ( β ( \hat{π} ( x ) - \hat{π} ( y ) ) )}{{( 1 + exp ( β ( \hat{π} ( x ) - \hat{π} ( y ) ) ) )}^{2}} & Equation ( 34 )\end{matrix}$$

Finally, substituting Equation (28), (33) and (34) into (32), and then substituting Equation (32) into (30), the gradient for ApproxAP (i.e., Δθ_{ApproxAP}) is obtained.

The general training process is illustrated by Algorithm 1, shown in Table 2. This process generates T ranking functions with parameters θ₁, θ₂, . . . , θ_{T}. Generally, a validation set (i.e., the “training data” representing a set of queries, corresponding documents, and relevance judgements or ranking scores) is used to select the best model for testing.

TABLE 2
Algorithm 1, as Applied to ApproxAP and/or ApproxNDCG

```
Inputs:
  m training queries, their associated documents and relevance judgments;
  Number of iterations, T;
  Learning rate, η;
Training:
  Initialize the parameter θ₀ of the ranking function f (x; θ);
  For t = 1 to T do
    Set θ = θₜ₋₁;
    Shuffle the m training queries;
    For i = 1 to m do
      Feed i-th training query (after shuffle) to the learning system;
      Compute the gradient, Δθ, of [symbol] for ApproxAP with respect to θ
        using Equation (30) for ApproxAP; or
      Compute the gradient, Δθ, of [symbol] for ApproxNDCG with respect to
        θ using Equation (27) for ApproxNDCG;
      Update parameter θ = θ + η × Δθ;
    End for
    Set θₜ = θ;
  End for
Output:
  Parameters of T ranking functions: {θ₁, θ₂, ... , θ_{T}}, (i.e., the
  “optimized ranking function”)
```

From the two examples described above (i.e., ApproxAP and ApproxNDCG), it can be seen that by using the optimization framework of the Ranking Optimizer, the corresponding surrogate objective function (i.e., the optimized tranking function) can be easily optimized using any of a number of existing optimization techniques, such as, for example, gradient methods. Consequently, measure specific optimization techniques are not needed.

2.4 Theoretical Analysis:

As is well known to those skilled in the art, relationships between surrogate objective functions and corresponding IR measures are not clear for conventional direct optimization methods. In contrast, the relation between the approximated surrogate functions within the optimization framework of the Ranking Optimizer and the IR measures described herein is clear and can be well investigated, as described below.

2.4.1 Position Function Approximation:

The approximation of positions is a basic component in the optimization framework of the Ranking Optimizer. In order to approximate an IR measure, the positions are first approximated. Further, in order to analyze the accuracy of the approximation of IR measures, the accuracy of approximation of positions is analyzed, as discussed below. However, note that if s_{x,y}=0 (i.e., document x and y have the same score), there will be no unique ranked list by sorting. This would bring uncertainty to corresponding IR measures. Therefore, for the sake of clarity and for purposes of explanation, the following discussion assumes that:

$$δ = {min}_{x , y ∈ X , x \neq y} \vert {s}_{x , y} \vert > 0 \qquad Equation ( 35 )$$

The following theorem shows that the position approximation in Equation (23) can achieve very high accuracy.
Theorem 3: Given a document collection X with n documents in it, for ∀α>0, Equation (23) can approximate the true position with the following accuracy:

$$\vert \hat{π} ( x ) - π ( x ) \vert < \frac{n - 1}{exp ( {δ}_{x} α ) + 1} \qquad Equation ( 36 )$$

where δₓ=min_{yεX,y≠x}|s_{x,y}|.

Theorem 3 can be proven in view of the following, where:

$$\vert \hat{π} ( x ) - π ( x ) \vert = {\sum }_{y ∈ X , y \neq x} ( \frac{exp ( - α {s}_{x , y} )}{1 + exp ( - α {s}_{x , y} )} - 1 \{ {s}_{x , y} < 0 \} ) \leq {\sum }_{y ∈ X , y \neq x} \vert \frac{exp ( - α {s}_{x , y} )}{1 + exp ( - α {s}_{x , y} )} - 1 \{ {s}_{x , y} < 0 \} \vert \qquad Equation ( 37 )$$

In particular, if it can be proven that for any document yεX,

$$\vert \frac{exp ( - α {s}_{x , y} )}{1 + exp ( –α {s}_{x , y} )} - 1 \{ {s}_{x , y} < 0 \} \vert < \frac{1}{exp ( {δ}_{x} α ) + 1} \qquad Equation ( 38 )$$

Then, this gives:

$$\vert \hat{π} ( x ) - π ( x ) \vert < {\sum }_{y ∈ X , y \neq x} \frac{1}{exp ( {δ}_{x} α ) + 1} = \frac{n - 1}{exp ( {δ}_{x} α ) + 1} \qquad Equation ( 39 )$$

The inequality represented in Equation (38) is then proven as discussed below by first considering s_{x,y}>0 and s_{x,y}<0 separately.

In particular, for s_{x,y}>0, Equation (35) gives:

1+exp(αs_{x,y})>1+exp(δₓα)

### Therefore,

$$\frac{Exp ( - α {s}_{x , y} )}{1 + exp ( - α {s}_{x , y} )} = \frac{1}{1 + exp ( α {s}_{x , y} )} < \frac{1}{1 + exp ( {δ}_{x} α )} .$$

Note that 1{s_{x,y}<0}=0 when s_{x,y}>0. Hence, for s_{x,y}>0,

$$\vert \frac{exp ( - α {s}_{x , y} )}{1 + exp ( - α {s}_{x , y} )} - 1 \{ {s}_{x , y} < 0 \} \vert < \frac{1}{1 + exp ( {δ}_{x} α )} .$$

Next, for s_{x,y}<0, Equation (35) gives:

1+exp(−αs_{x,y})>1+exp(δₓα).

Note that 1{s_{x,y}<0}=1 when s_{x,y}<0. Hence, for s_{x,y}<0,

$$\vert \frac{exp ( - α {s}_{x , y} )}{1 + exp ( - α {s}_{x , y} )} - 1 \{ {s}_{x , y} < 0 \} \vert = \frac{1}{1 + exp ( - α {s}_{x , y} )} < \frac{1}{1 + exp ( {δ}_{x} α )}$$

Combining each of these two cases (i.e., “s_{x,y}>0” and “s_{x,y}<0”) results in Equation (38). Therefore, in accordance with Equation (39), Theorem 3 is correct.

In accordance with Theorem 3, when δₓ and α are large, the approximation will be very accurate. For example,

$${lim}_{{δ}_{x} α -> ∞} \hat{π} ( x ) = π ( x ) . \qquad Equation ( 40 )$$

A corollary of Theorem 3 is given below:
Corollary 4: Given a document collection X with n documents in it, for ∀α>0, Equation (23) can approximate the true position with an accuracy as below.

$$ɛ {=}^{Δ} {max}_{x ∈ X} \vert \hat{π} ( x ) - π ( x ) \vert < \frac{n - 1}{exp ( δ α ) + 1} \qquad Equation ( 41 )$$

For the example in Table 1, the following shows that an accurate approximation is achieved by applying the data to Equation (41):

$$0.00118 = ɛ < \frac{5 - 1}{exp ( 0.06744 * 100 ) + 1} \approx 0.00471$$

2.4.2 Measure Approximation:

The following theorem quantifies the error in the approximation of MAP:
Theorem 4: If the error, ε, of the position approximation in Equation (41) is smaller than 0.5, then:

$$\vert \hat{AP} - AP \vert < \frac{1}{1 + exp ( β ( 1 - 2 ɛ ) )} {\sum }_{i = 1}^{\vert {D}_{+} \vert} \frac{1}{i - ɛ} + 2 ɛ {\sum }_{i = 1}^{\vert {D}_{+} \vert} \frac{1}{i \cdot ( i - ɛ )} \qquad Equation ( 42 )$$

Therefore, Theorem 4 indicates that when ε is small and β is large, the approximation of AP can be very accurate. In the extreme case, this gives the following:

$${lim}_{ɛ -> 0 , β -> ∞} \hat{AP} = AP \qquad Equation ( 43 )$$

For the example provided in Table 1, setting β=100, |D₊|=1, this results in | [symbol] −AP|<0.0024. In other words, the AP approximation is clearly very accurate in this case.

The following theorem quantifies the error in the approximation of NDCG:
Theorem 5: The approximation error of [symbol] can be bounded as:

$$\vert \hat{NDCG} - NDCG \vert < \frac{ɛ}{2 ln 2} \qquad Equation ( 44 )$$

This theorem indicates that when E is small, the approximation of NDCG can be very accurate. In the extreme case, this gives the following:

$${lim}_{ɛ -> 0} \hat{NDCG} = NDCG \qquad Equation ( 45 )$$

For example, based on the example provided in Table 1, this results in

$$\vert \hat{NDCG} - NDCG \vert < \frac{ɛ}{2 ln 2} \approx 0.00085 .$$

In other words, the NDCG approximation is again very accurate in this case.

From these two examples (AP and NDCG), one can see that the surrogate functions in the framework can be very accurate approximations to IR measures.

2.4.3 Justification of Accurate Approximation:

In view of the proceeding discussion, it should be clear that the surrogate objective function obtained using the optimization framework of the Ranking Optimizer will be very close to the original IR measure. This high accuracy in the approximation is very important for a direct optimization method, as discussed below.

As discussed above in Section 2.2, directly optimizing IR measures will likely lead to a very good (i.e., highly accurate) test performance. However, this raises the question of whether, after using the surrogate objective function, the same or similar conclusion can be still be reached with respect to test performance. This question is addressed by the following discussion.

In particular, the following discussion uses the term \hat{ƒ}ₘ to indicate the ranking function in F with the best training performance in terms of the surrogate objective function, \hat{M}:

$${\hat{f}}_{m} = {argmax}_{f ∈ ℱ} {\hat{M}}_{m} ( f ) \qquad Equation ( 46 )$$

which leads to Theorem 6, as follows:
Theorem 6: The difference between the testing performance \hat{ƒ}ₘ and the testing performance ƒ* can be bounded as illustrated by Equation (47):

$$\vert M ( {\hat{f}}_{m} ) - M ( {f}^{*} ) \vert \leq 2 {sup}_{f ∈ ℱ} \vert M ( f ) - {M}_{m} ( f ) \vert + 2 {sup}_{f ∈ ℱ} \vert {M}_{m} ( f ) - {\hat{M}}_{m} ( f ) \vert \qquad Equation ( 47 )$$

Note that Theorem 1 implies that:

$${sup}_{f ∈ ℱ} \vert M ( f ) - {M}_{m} ( f ) \vert {->}^{m -> ∞} 0. \qquad Equation ( 48 )$$

thus, given the following:

$${sup}_{f ∈ ℱ} \vert {M}_{m} ( f ) - {\hat{M}}_{m} ( f ) \vert {->}^{m -> ∞} 0 , \qquad Equation ( 49 )$$

it can be seen that:

$$\vert M ( {\hat{f}}_{m} ) - M ( {f}^{*} ) \vert {->}^{m -> ∞} 0. \qquad Equation ( 50 )$$

In other words, if the surrogate objective function is sufficiently close to the IR measure (i.e., sup_{fεF}|Mₘ(ƒ)−\hat{M}ₘ(ƒ)|^{m→∞}→0), then the test performance of the ranking function learned by a method of optimizing the surrogate objective function will converge to the best possible test performance that can be obtained in the large sample limit.

3.0 Operational Summary of the Ranking Optimizer:

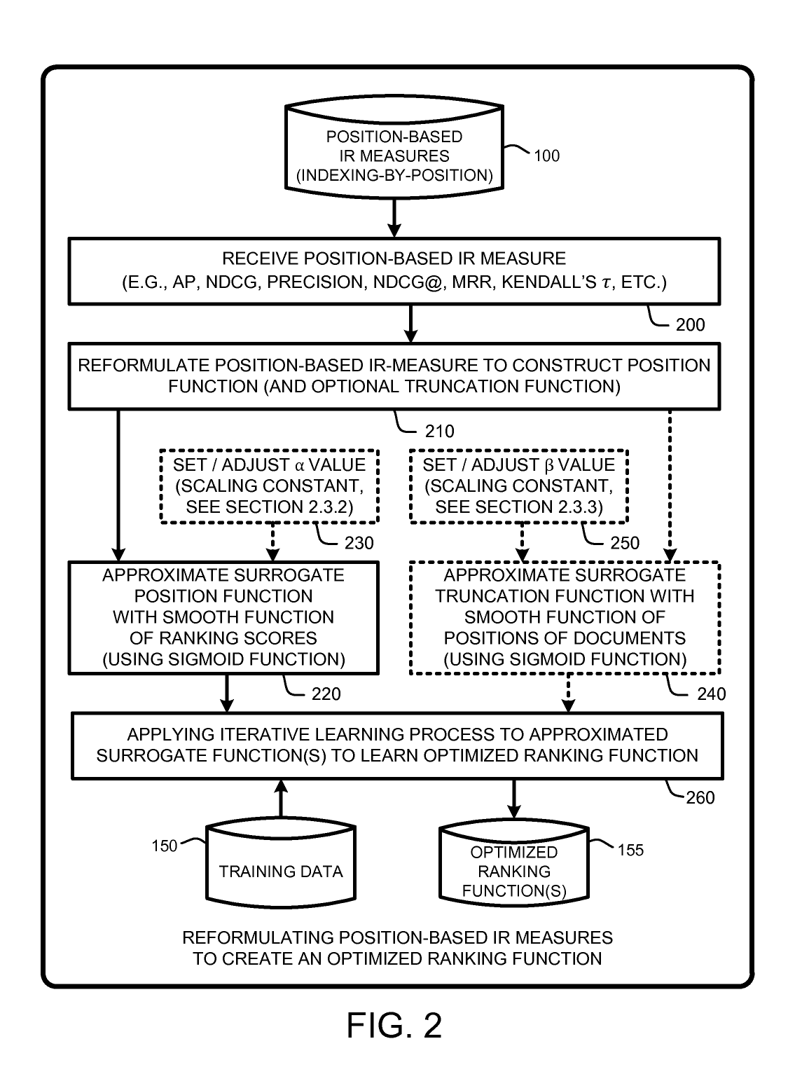

The processes described above with respect to FIG. 1, and in further view of the detailed description provided above in Sections 1 and 2, are illustrated by the general operational flow diagram of FIG. 2. In particular, FIG. 2 provides an exemplary operational flow diagram that summarizes the operation of some of the various embodiments of the Ranking Optimizer. Note that FIG. 2 is not intended to be an exhaustive representation of all of the various embodiments of the Ranking Optimizer described herein, and that the embodiments represented in FIG. 2 are provided only for purposes of explanation.

Further, it should be noted that any boxes and interconnections between boxes that are represented by broken or dashed lines in FIG. 2 represent optional or alternate embodiments of the Ranking Optimizer described herein, and that any or all of these optional or alternate embodiments, as described below, may be used in combination with other alternate embodiments that are described throughout this document.

In general, as illustrated by FIG. 2, the Ranking Optimizer begins operation by receiving 200 the position based IR measure 100. As discussed above, the particular IR measure 100 can be any conventional IR measure that may optionally include a truncation function, depending upon the definition of that IR measure. Examples of IR measures 100 include AP, NDCG, Precision, NDCG@k, MRR, Kendall's r, etc.

Next, the Ranking Optimizer reformulates 210 the position-based IR measure 100 to construct a position function and an optional truncation function (depending upon the original position based IR measure 100). As discussed above, both of these functions are non-continuous and non-differentiable. Therefore, the Ranking Optimizer next approximates these functions using some sigmoid function.

In particular, the position function is approximated 220 as a smooth function of ranking scores (rather than positions) using a sigmoid function. In making this approximation 220, a scaling constant, a, is set or adjusted 230 to control a tradeoff between accuracy and computational overhead (see Section 2.3.2), with higher values corresponding to increased accuracy and increased computational overhead. Similarly, the truncation function is approximated 240 as a smooth function of positions of documents using a sigmoid function. In making this approximation 240, a scaling constant, β, is set or adjusted 250 to control a tradeoff between accuracy and computational overhead (see Section 2.3.3), with higher values corresponding to increased accuracy and increased computational overhead.

Finally, an iterative learning process 260 is applied to the approximated functions in combination with the set of training data 150 to learn the optimized ranking function 155 (also referred to as a surrogate IR measure). The learned optimized ranking function 155 is then used in place of the original position-based IR-measure for the particular IR task that is being implemented (e.g., ranking, search, recommendation-type applications, document retrieval, collaborative filtering, key term extraction, definition finding, email routing, sentiment analysis, product rating, anti-spam applications, etc.). Note that the training data 150 is dependent upon the particular IR measure being evaluated. For example, in the case of a document search type IR measure, the training data would consist of ranked lists of documents associated with each query in a set of queries.

4.0 Exemplary Operating Environments:

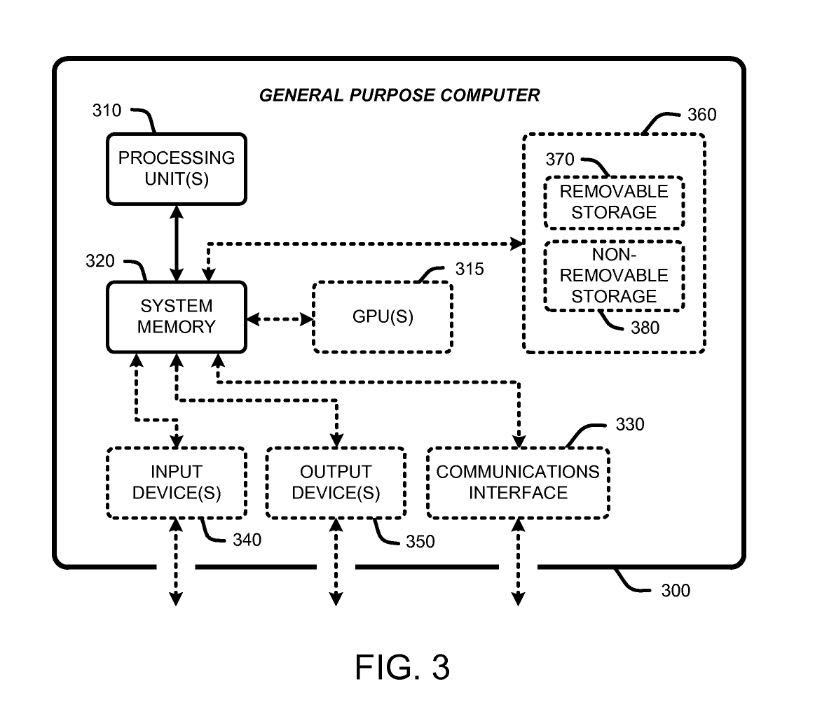

The Ranking Optimizer described herein is operational within numerous types of general purpose or special purpose computing system environments or configurations. FIG. 3 illustrates a simplified example of a general-purpose computer system on which various embodiments and elements of the Ranking Optimizer, as described herein, may be implemented. It should be noted that any boxes that are represented by broken or dashed lines in FIG. 3 represent alternate embodiments of the simplified computing device, and that any or all of these alternate embodiments, as described below, may be used in combination with other alternate embodiments that are described throughout this document.

For example, FIG. 3 shows a general system diagram showing a simplified computing device 300. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, video media players, etc.

To allow a device to implement the Ranking Optimizer, the device should have a sufficient computational capability and system memory. In particular, as illustrated by FIG. 3, the computational capability is generally illustrated by one or more processing unit(s) 310, and may also include one or more GPUs 315, either or both in communication with system memory 320. Note that that the processing unit(s) 310 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 3 may also include other components, such as, for example, a communications interface 330. The simplified computing device of FIG. 3 may also include one or more conventional computer input devices 340. The simplified computing device of FIG. 3 may also include other optional components, such as, for example, one or more conventional computer output devices 350. Finally, the simplified computing device of FIG. 3 may also include storage 360 that is either removable 370 and/or non-removable 380. Such storage includes computer readable media including, but not limited to, DVD's, CD's, floppy disks, tape drives, hard drives, optical drives, solid state memory devices, etc. Further, software embodying the some or all of the various embodiments, or portions thereof, may be stored on any desired combination of computer readable media in the form of computer executable instructions. Note that typical communications interfaces 330, input devices 340, output devices 350, and storage devices 360 for general-purpose computers are well known to those skilled in the art, and will not be described in detail herein.

The foregoing description of the Ranking Optimizer has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the Ranking Optimizer. It is intended that the scope of the invention be limited not by this detailed description, but rather by the claims appended hereto.

What is claimed is:

1. A method for learning a ranking function to optimize a surrogate of a position-based information retrieval (IR) measure, comprising steps for:
receiving a non-continuous and non-differentiable position-based IR measure;
reformulating the position-based IR measure from an indexing-by-position measure to an indexing-by-object measure to create a position function;
approximating the position function as a smooth function of ranking scores;
generate a surrogate of the IR measure using the approximated position function;
iteratively learning a ranking function by optimizing the surrogate of the IR measure based on one or more sets of training data corresponding to the position-based IR measure; and
providing the ranking function for use in a computer-based information retrieval process.

2. The method of claim 1 wherein the position-based IR measure includes a truncation function, and further comprising steps for approximating the truncation function as a smooth function of positions of objects.

3. The method of claim 2 wherein the surrogate of the IR measure is further learned from the smooth function of positions of objects based on the one or more sets of training data.

4. The method of claim 1 further comprising providing a first adjustable scaling constant for use in approximating the position function, said first adjustable scaling constant allowing a tradeoff between approximation accuracy and computational overhead.

5. The method of claim 2 further comprising providing a second adjustable scaling constant for use in approximating the truncation function, said second adjustable scaling constant allowing a tradeoff between approximation accuracy and computational overhead.

6. The method of claim 1 wherein the position-based IR measure is the “Average Precision” (“AP”) IR measure, and wherein a gradient of the approximated surrogate IR measure (i.e., “AP”) is given by:
$$\frac{\partial \hat{AP}}{\partial θ } = \frac{- 1}{\vert {D}_{+} \vert} {\sum }_{y} \frac{r ( y )}{{\hat{π}}^{2} ( y )} \frac{\partial \hat{π} ( y )}{\partial θ} + \frac{1}{\vert {D}_{+} \vert} {\sum }_{y} {\sum }_{x \neq y} r ( y ) r ( x ) \frac{\partial J ( θ )}{\partial θ}$$

7. The method of claim 1 wherein the position-based IR measure is the “Normalized Discounted Cumulative Gain” (“NDCG”) IR measure, and wherein a gradient of the approximated surrogate IR measure (i.e., “NDCG”) is given by:
$$\frac{\partial \hat{NDCG}}{\partial θ} {N}_{n}^{- 1} {\sum }_{x} \frac{\partial \frac{ {2}^{r ( x )} - 1}{{log}_{2} ( 1 + \hat{π} ( x ) )}}{\partial \hat{π} ( x )} \frac{\partial \hat{π} ( x )}{\partial θ}$$

8. The method of claim 1 wherein the computer-based information retrieval process is an object recommendation system that returns a set of one or more ranked object recommendations based on a user entered query.

9. A system for constructing a ranking function by optimizing a non-continuous and non-differentiable position-based information retrieval (IR) measure, comprising:
a device for reformulating a position-based IR measure from an indexing-by-position measure to an indexing-by-object measure to create a position function, and if the position-based IR measure includes a truncation function, further creating a corresponding truncation function;
a device for approximating the position function as a smooth function of ranking scores;
a device for approximating the corresponding truncation function as a smooth function of positions of objects;
a device for generating a surrogate of the position-based IR measure based on the approximated position function and the approximated truncation function; and
a device for learning a ranking function by iteratively optimizing the surrogate of the position-based IR measure.

10. The system of claim 9 further comprising a computer-based information retrieval system that uses the learned ranking function to return IR results in response to one or more queries.

11. The system of claim 10 wherein the computer-based information retrieval process is a document search system that returns a list of one or more ranked documents in response to one or more user entered queries.

12. The system of claim 9 further comprising providing a first adjustable scaling constant for use in approximating the position function, said first adjustable scaling constant allowing a tradeoff between approximation accuracy and computational overhead.

13. The system of claim 9 further comprising providing a second adjustable scaling constant for use in approximating the truncation function, said second adjustable scaling constant allowing a tradeoff between approximation accuracy and computational overhead.

14. The system of claim 9 wherein the position-based IR measure is the “Average Precision” (“AP”) IR measure, and wherein a gradient of the surrogate IR measure (i.e., “ [symbol] ”) is given by:
$$\frac{\partial \hat{AP}}{\partial θ} = \frac{- 1}{\vert {D}_{+} \vert} {\sum }_{y} \frac{r ( y )}{{\hat{π}}^{2} ( y )} \frac{\partial \hat{π} ( y )}{\partial θ} + \frac{1}{\vert {D}_{+} \vert} {\sum }_{y} {\sum }_{x \neq y} r ( y ) r ( x ) \frac{\partial J ( θ )}{\partial θ}$$

15. The system of claim 9 wherein the position-based IR measure is the “Normalized Discounted Cumulative Gain” (“NDCG”) IR measure, and wherein a gradient of the surrogate IR measure (i.e., “ [symbol] ”) is given by:
$$\frac{\partial \hat{NDCG}}{\partial θ} = {N}_{n}^{- 1} {\sum }_{x} \frac{\partial \frac{{2}^{r ( x )} - 1}{{log}_{2} ( 1 + \hat{π} ( x ) )}}{\partial \hat{π} ( x )} \frac{\partial \hat{π} ( x )}{\partial θ}$$

16. A computer-readable medium having computer executable instructions stored therein for learning an optimized surrogate information retrieval (IR) measure from a position-based IR measure, said instructions causing a computing device to:
receive a non-continuous and non-differentiable position-based IR measure;
reformulate the position-based IR measure from an indexing-by-position measure to an indexing-by-object measure to create a ranking-based position function, and, if the position-based IR measure includes a truncation function, further creating a corresponding truncation function;
approximate the position function as a smooth function of ranking scores using a first sigmoid function;
approximate the corresponding truncation function as a smooth function of positions of objects using a second sigmoid function;
generate a surrogate of the position-based IR measure using the approximated position function and the approximated truncation function;
iteratively learn a ranking function by optimizing the surrogate of the IR measure based on one or more sets of training data; and
provide the learned ranking function for use in a computer-based information retrieval process.

17. The computer-readable medium of claim 16 wherein the computer-based information retrieval process is a document search system that returns a list of one or more ranked documents in response to one or more queries.

18. The computer-readable medium of claim 16 wherein the computer-based information retrieval process is an object recommendation system that provides a list of ranked objects in response to a query.

19. The computer-readable medium of claim 16 further comprising providing a first adjustable scaling constant for use in approximating the position function, said first adjustable scaling constant controlling approximation accuracy relative to computational overhead.

20. The computer-readable medium of claim 16 further comprising providing a second adjustable scaling constant for use in approximating the corresponding truncation function, said second adjustable scaling constant controlling approximation accuracy relative to computational overhead.
